(19) United States
(12) Patent Application Publication
(10) Pub. No.: US 2009/0031074 A1
(43) Pub. Date: Jan. 29, 2009

(54) Multi-level Cell Flash Memory and Method of Programming the Same

(76) Inventor: Chang-Il Son, Yongin-si (KR)

Correspondence Address: F. CHAU & ASSOCIATES, LLC, 130 WOODBURY ROAD, WOODBURY, NY, 11797, US

(21) Appl. No.: 12/177,491

(22) Filed: Jul. 22, 2008

(30) Foreign Application Priority Data
Jul. 27, 2007 (KR) 10-2007-0075694

(51) Int. Cl. G06F 12/02

(52) U.S. Cl. 711/103; 711/E12.008

(57) ABSTRACT

Provided is a flash memory having a multi-level cell (MLC) and a method of programming the same. The method includes identifying a set of first patterns from input data, determining whether there is a set of second patterns stored within the flash memory that is of a number substantially similar to the number of the first patterns, and programming the input data as a most significant bit (MSB) in a location of the flash memory where the identified set of second patterns is stored when it is determined that there is a set of second patterns stored within the flash memory that is of a number substantially similar to the number of first patterns.

### CROSS-REFERENCE TO RELATED APPLICATIONS

This application claims priority under 35 U.S.C. § 119 to Korean Patent Application No. 10-2007-0075694, filed on Jul. 27, 2007, the entire contents of which are hereby incorporated by reference.

### BACKGROUND OF THE INVENTION

The present invention relates to a memory device, and more particularly, to a flash memory having a multi-level cell (MLC) and a method of programming the same.

Flash memory is a form of solid-state memory that is able to retain information in the absence of supplied power. Flash memory may either be NAND flash memory or NOR flash memory. NOR flash memory includes memory cells that are individually connected to bit lines and word lines, respectively. Accordingly, NOR flash memory has excellent random access time characteristics.

NAND flash memory includes memory cells that are connected in series, such that only one contact is required at each string. Accordingly, NAND flash memory has excellent integration characteristics, for example, high capacity memory devices may be formed in a relatively small package.

Recently, research relating to flash memory having multi-level cells (MLC) capable of storing a plurality of data in one memory cell has been in progress in order to enhance the degree of integration of the flash memory over conventional flash memory having single-level cells (SLC). The MLC has at least two threshold voltage distributions and also has at least two corresponding data storage states.

For example, the MLC capable of programming two-bit data has four data storage states, i.e., [11], [10], [01], and [00]. These distributions correspond to threshold voltage distributions of the MLC, respectively. For example, where threshold voltages distributions of a memory cell are below about −2.7 V, between about 0.3 V to about 0.7 V, between about 1.3 V to about 1.7 V, and between about 2.3 V to about 2.7 V, respectively, the [11] corresponds to below about −2.7 V, the [10] corresponds to between about 0.3 V to about 0.7 V, the [01] corresponds to between about 1.3 V to about 1.7 V, and the [00] corresponds to between about 2.3 V to about 2.7 V.

If a threshold voltage of the MLC corresponds to one of four threshold voltage distributions, corresponding 2-bit data information among [11], [10], [01], and [00] are stored in the memory cell.

For MLC flash memory having 2-bits, data is stored as a least significant bit (LSB) and a most significant bit (MSB). In the NAND flash memory, a program time for programming the LSB is about 200 μs and a program time for programming the MSB is about 1.2 ms. Accordingly, the MLC of the NAND flash memory takes longer time for programming a memory cell than the SLC.

Additionally, if the MLC is programmed repeatedly, its endurance is deteriorated faster compared to the SLC.

### SUMMARY OF THE INVENTION

Exemplary embodiments of the present invention provide a method of reducing the number of programming a flash memory. Exemplary embodiment of the present invention also provide a method of reducing a program time of a flash memory. Exemplary embodiments of the present invention also provide a method of increasing endurance of a memory cell in a flash memory.

Exemplary embodiments of the present invention provide a method of programming a flash memory, the method includes determining a plurality of least significant bit (LSB) patterns. The respective numbers of the LSB patterns in input data are counted and the number of first patterns is outputted. The number of second patterns that is the most similar to the number of the first patterns are searched for among the total number of the second LSB patterns representing the respective numbers of the LSB patterns in each data stored in a memory. The input data is programmed as a most significant bit (MSB) in a position where data corresponding to the most similar numbers of the second patterns in the memory are stored.

In some exemplary embodiments, the input data is programmed as an LSB when the memory is erased. In some exemplary embodiments, when data stored in an LSB programmed cell and the input data have the same value, only a flag cell of the LSB programmed cell is programmed. In some exemplary embodiments, the LSB patterns are determined based on a file format of the input data and whether the input data are compressed or not. In some exemplary embodiments of the present invention, memory devices include a processor determining a plurality of LSB patterns and a memory storing the numbers of second patterns that represent the respective numbers of the LSB patterns in a plurality of data. The processor counts the respective numbers of the LSB patterns in inputted data from a host and outputs the numbers of first patterns. The numbers of second LSB patterns that are the most similar to the numbers of the first patterns are searched for. The input data is programmed as an MSB in a position where data corresponding to the most similar numbers of the second patterns in the memory are stored.

In some exemplary embodiments, the input data is programmed as an LSB when the memory is erased. In some exemplary embodiments, when data stored in an LSB programmed cell and the input data have the same value, only a flag cell of the LSB programmed cell is programmed. In some exemplary embodiments, the LSB patterns are determined based on a file format of the input data and whether the input data are compressed or not. In some exemplary embodiments, the memory includes a random access memory (RAM) and a flash memory. In some exemplary embodiments, before a power source is turned off, the processor stores the LSB patterns and the second patterns, which are stored in the RAM, into the flash memory.

In some exemplary embodiments, when a power source is turned on, the processor stores the LSB patterns and the second patterns, which are stored in the flash memory, into the RAM. In some exemplary embodiments, the memory is a MLC.

In some exemplary embodiments of the present invention, methods of programming a flash memory include determining a pattern of input data, searching LSB pattern information that is the most similar to the determined pattern among all LSB pattern information stored in a memory, and programming the input data as an MSB in a position corresponding to the most similar LSB pattern information of the memory.

In some exemplary embodiments, the determining of the pattern includes determining a plurality of LSB patterns and counting the respective numbers of the LSB patterns in the input data and outputting the numbers of first patterns.

In some exemplary embodiments, the LSB pattern information stored in the memory includes the numbers of second patterns representing the respective numbers of the LSB patterns.

In some exemplary embodiments, the searching of the LSB pattern information includes searching the most similar numbers of the second patterns among the numbers of the first patterns and the LSB pattern information stored in the memory.

### BRIEF DESCRIPTION OF THE DRAWINGS

The above and other features and aspects of the exemplary embodiments of the present invention will be described in detail with reference to the accompanying drawings, in which:

FIG. 1 is a block diagram illustrating a system of a NAND flash memory according to an exemplary embodiment of the present invention;

FIG. 2 is a view illustrating a programming method according to an exemplary embodiment of the present invention;

FIG. 3 is a timing diagram illustrating a page program timing of the NAND flash memory of FIG. 1;

FIG. 4 is a block diagram of an LSB pattern of FIG. 1; and

FIG. 5 is a block diagram of the NAND flash memory of FIG. 1.

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be construed as limited to the embodiments set forth herein.

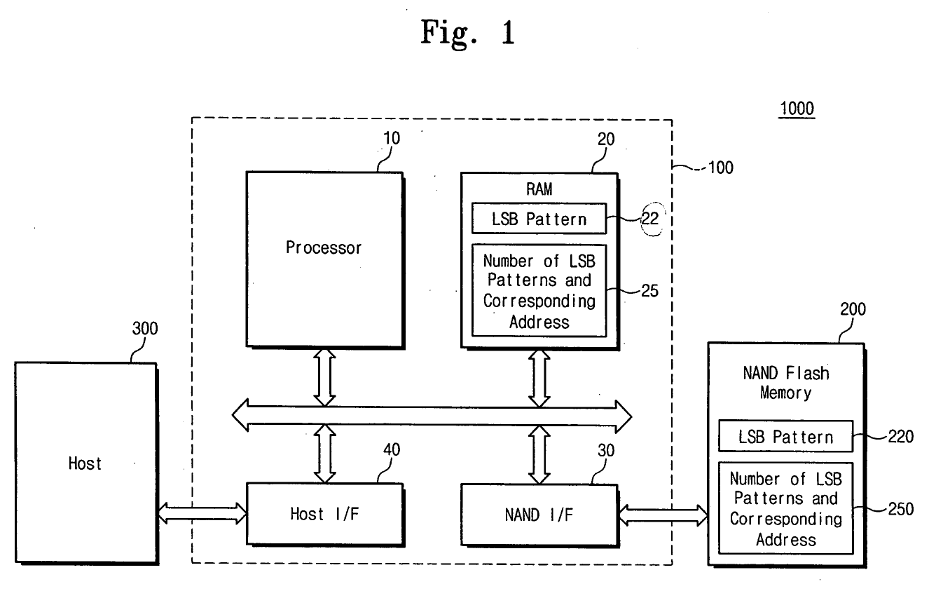

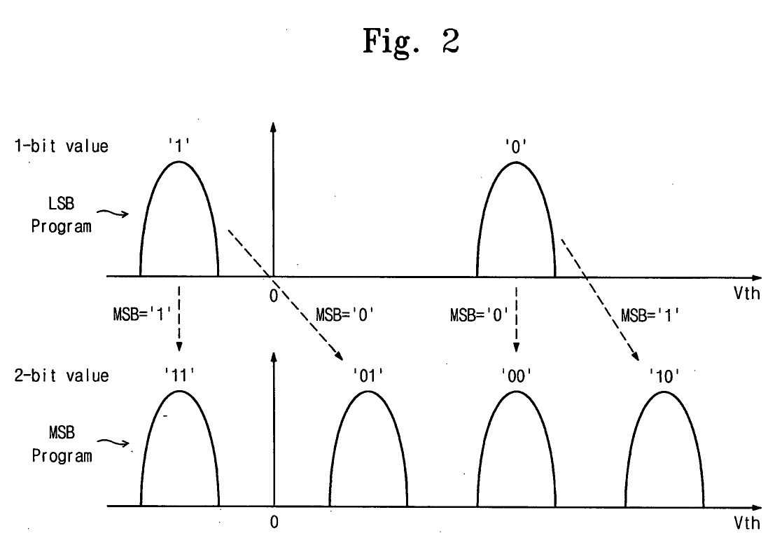

FIG. 1 is a block diagram illustrating a system of a NAND flash memory according to an exemplary embodiment of the present invention. FIG. 2 is a view illustrating a programming method according to an exemplary embodiment of the present invention.

Referring to FIG. 1, a flash memory system 1000 includes a memory controller 100, a NAND flash memory 200, and a host 300.

The memory controller includes a processor 10, a RAM 20, and a NAND interface 30 (hereinafter, referred to as I/F), and a host interface (hereinafter, referred to as I/F) 40.

The processor 10 analyzes transmitted data from the host 300. The processor 10 determines a plurality of LSB patterns based on an analyzed result. The processor 10 divides the transmitted data from the host 300 into predetermined bits. For example, the exemplary embodiments of the present invention assume that the predetermined bits are 8-bits. The processor 10 stores the 8-bit data in the RAM 20.

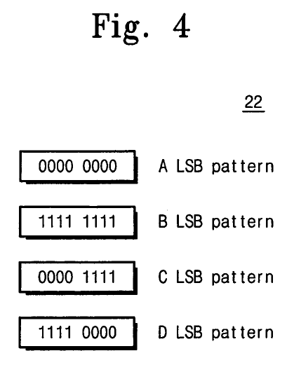

The processor 10 compares a plurality of data stored in the RAM 20. For example, the processor 20 determines whether there are overlapping data among the data stored in the RAM 20. If there are overlapping data, the processor 10 interprets the overlapping data as a least significant bit (LSB) pattern. The LSB pattern of exemplary embodiments of the present invention will be described in more detail with reference to FIG. 4.

Additionally, an LSB pattern 22 is determined by a user. For example, a user determines a plurality of the LSB patterns 22 according to a file format of data transmitted from the host 300 and/or whether data are compressed or not.

For example, if data transmitted from the host have compressed file formats such as JPG, AVI, MP3, etc, each file includes a unique header. For example, if data includes a JPG file, the file has a JPG header. If data includes an MP3 file, the file has an MP3 header. In these cases, the LSB pattern 22 is overlapping data in a header of each file format.

Additionally, if data transmitted from a host has uncompressed file formats such as WAV, TXT, BMP, RAW, etc, each data may include repeating patterns such as 00000000 and 11111111. In this case, the LSB pattern would be 00000000 and 11111111.

The RAM 20 includes an LSB pattern 22, and the number of LSB patterns, and a corresponding address 25. The NAND I/F 30 connects the NAND flash memory 200 with the memory controller 100. The processor 10 controls the NAND flash memory 200 through the NAND I/F 30. The host I/F 40 connects the memory controller 100 with the host 300. The processor 10 communicates with the host 300 through the host I/F 40. The NAND flash memory 200 includes an LSB pattern 220, and the number of LSB patterns and a corresponding address 250.

Before the flash memory system 1000 is turned off, the processor 10 stores the LSB pattern 220, the number of LSB patterns, and the corresponding address 250 of the RAM 20 in the NAND flash memory 200.

If the flash memory system 1000 is turned on, the processor 10 loads the LSB pattern 220, and the number of LSB patterns and a corresponding address 250 of the NAND flash memory 250 into the RAM 20.

A method of programming a MLC according to an exemplary embodiment of the present invention will be described below. Referring to FIGS. 1 and 2, a programming method according to an exemplary embodiment of the present invention includes programming a memory cell as an LSB and then programmed the LSB programmed cell as a most significant bit (MSB). If the next data is inputted into an LSB programmed cell, the next inputted data is programmed as an MSB. Otherwise, the next inputted data is programmed as an LSB.

For example, if the first inputted data is 1, it is programmed as an LSB in an arbitrary memory cell. If the next inputted data is 1, it is programmed as an MSB in the LSB programmed cell. Accordingly, a threshold voltage of the LSB programmed 1 is the same as the MSB programmed 11. Accordingly, an actual program operation is not performed in the LSB programmed cell. However, the programming method of an exemplary embodiment of the present invention programs a flag cell that determines whether an MSB has been programmed.

Additionally, if the first inputted data is 0 and the next inputted data is 0, the next inputted data is programmed as an MSB in the LSB programmed cell according to an exemplary embodiment of the present invention. For example, a threshold voltage of the LSB programmed 0 is the same as a threshold voltage of the MSB programmed 00. Accordingly, an actual program operation is not performed in the LSB programmed cell. However, a flag cell that identifies whether an MSB of the memory cell has been programmed is programmed according to an exemplary embodiment of the present invention.

According to an exemplary embodiment of the present invention, an actual program operation is not performed on the LSB programmed cell but only the flag cell is programmed, such that the number of programming steps for a cell in a flash memory is reduced. Accordingly, a programming time of a flash memory is reduced and also endurance of a flash memory is enhanced.

Additionally, exemplary embodiments of the present invention are effectively applied to a case where the same data or similar data are repeatedly inputted.

However, if the first inputted data is 1 and the next inputted data is 0, or the first inputted data is 0 and the next inputted data is 1, the first inputted data is programmed as an LSB in an arbitrary cell. The next inputted data is programmed as an MSB in the LSB programmed cell. Similar programming operations may be performed to program the MSB and the LSB.

A programming method according to an exemplary embodiment of the present invention performs programming on a cell as an MSB to change a threshold voltage of an LSB programmed cell in a state 1 into a threshold voltage corresponding to a state 01, or a threshold voltage of an LSB programmed cell in a state 0 into a threshold voltage corresponding to a state 10.

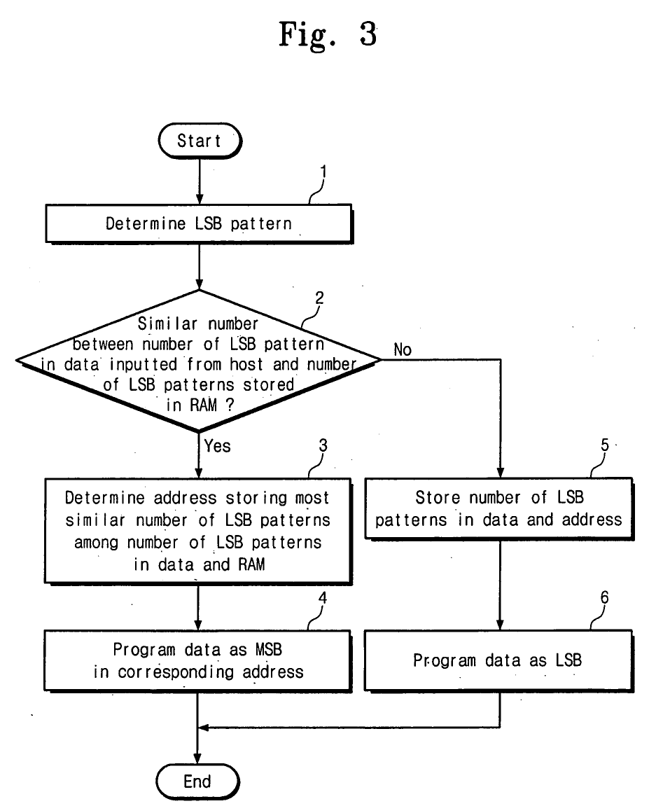

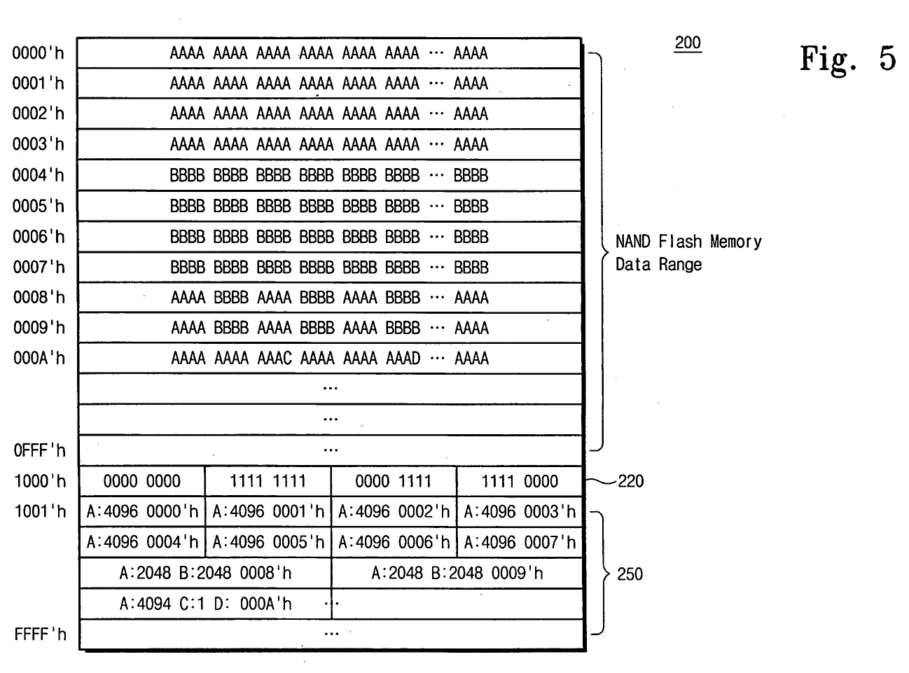

FIG. 3 is a timing diagram illustrating a page program timing of the NAND flash memory of FIG. 1. FIG. 4 is a block diagram of the LSB pattern of FIG. 1. FIG. 5 is a block diagram of the NAND flash memory of FIG. 1.

Referring to FIGS. 1 through 5, the processor 10 analyzes data inputted from the host 300, and determines a plurality of LSB patterns 22 based on an analyzed result in operation 1. The determined LSB patterns 22 are stored in the RAM 20 according to a control of the processor 10.

The processor 10 determines whether the respective numbers of the LSB patterns in data inputted from the host 200 is similar to the respective numbers of the LSB patterns 22 stored in the RAM 20 in operation 2. For example, the LSB pattern according to an exemplary embodiment of the present invention is illustrated in FIG. 4.

The processor 10 determines a plurality of LSB patterns A, B, C, and D. The A LSB pattern is 00000000, the B LSB pattern is 1111111, the C LSB pattern is 0000111, and the D LSB pattern is 11110000. Referring to FIG. 5, the NAND flash memory 200 includes a data region stored as an LSB, a plurality of LSB patterns 220 to be loaded during booting of the flash memory system 1000, and information 250 including the number of LSB patterns in the data region and an address. The address of 0000′h through the address 0FFF′h in the NAND flash memory 200 represent a data region that is programmed as an LSB. Data in the data region are expressed in the LSB pattern according to exemplary embodiments of the present invention. One address of FIG. 5 represents one page. One page may include 4 Kbytes of data. If, for example, one page includes only the A LSB pattern, the number of A LSB patterns in one page is 4096.

It is determined whether the data inputted from a host includes A, B, C, or D LSB patterns. If there is the A LSB pattern in the inputted data, the processor 10 counts the number of the A LSB patterns. Additionally, if there is the B LSB pattern in the inputted data, the processor 10 counts the number of the B LSB patterns.

The processor 10 compares the number of the A LSB patterns or the number of the B LSB patterns in the inputted data with the respective numbers of the LSB patterns stored in the RAM 20.

If there is a similar number of the LSB patterns in the data and the respective numbers of the LSB patterns stored in the RAM 20, the processor 10 determines an address having the most similar number of the LSB patterns in the data and the respective numbers of the LSB patterns stored in the RAM 20 in operation 3. The processor 10 programs the data in the determined address of the NAND flash memory 200 as an MSB in operation 4.

Where the respective numbers of the LSB patterns in the data and the respective numbers of the LSB patterns stored in the RAM 20 are dissimilar, the processor 10 stores the respective numbers and addresses of the LSB patterns in the data into the RAM 20 in operation 5.

A method of programming an MLC according to an exemplary embodiment of the present invention includes programming inputted data from a host as an MSB in a region similar to data programmed as an LSB in a flash memory. Accordingly, exemplary embodiments of the present invention reduce the number of programming steps necessary for programming flash memory cells by including cells where an actual program operation is not performed.

The processor 10 programs the data as an LSB in the address of the NAND flash memory 200 in operation 6.

Before the flash memory system 1000 is turned off, the processor 10 stores the LSB pattern 22 stored in the RAM 20 and also the respective numbers of the LSB patterns and corresponding addresses 25 in the NAND flash memory 200.

When the flash memory system 1000 is turned on, the processor 10 loads LSB patterns 220 and the respective numbers of the LSB patterns and a corresponding address 250 stored in the NAND flash memory 200 into the RAM 20.

Accordingly, exemplary embodiments of the present invention reduce the number of programming steps that are required to program a flash memory cell. Accordingly, a program time of a flash memory is reduced and also the endurance of a flash memory cell is enhanced.

The above-disclosed subject matter is to be considered illustrative, and not restrictive, and are intended to cover all modifications, enhancements, and other embodiments, which fall within the true spirit and scope of the present invention

What is claimed is:

1. A method of programming a flash memory, the method comprising:
identifying a set of first patterns from input data;
determining whether there is a set of second patterns stored within the flash memory that is of a number substantially similar to the number of the first patterns; and
programming the input data as a most significant bit (MSB) in a location of the flash memory where the identified set of second patterns is stored when it is determined that there is a set of second patterns stored within the flash memory that is of a number substantially similar to the number of first patterns.

2. The method of claim 1, wherein the input data is programmed as a LSB in the flash memory when it is determined that there is not a set of second patterns stored within the flash memory that is of a number substantially similar to the number of first patterns.

3. The method of claim 2, wherein the flash memory is blank.

4. The method of claim 1, wherein, when data stored in an LSB programmed cell of the flash memory and the input data have the same value, only a flag cell of the LSB programmed cell is programmed in writing the input data to the flash memory cell.

5. The method of claim 1, wherein the set of first patterns are identified based on a file format of the input data or based on whether the input data are compressed.

6. The method of claim 1, wherein the flash memory is a multi-level cell (MLC).

7. A memory device comprising:
a processor identifying a set of first patterns from within input data received by a host; and
a memory storing a set of second patterns,
wherein the processor counts the numbers of identified first patterns and outputs the counted number of first patterns;
determines whether there is a set of second patterns stored within the memory that is of a number substantially similar to the numbers of the first patterns; and
programs the input data as an MSB in a location of the memory where the identified set of second patterns is stored when it is determined that there is a set of second patterns stored within the memory that is of a number substantially similar to the number of first patterns.

8. The memory device of claim 7, wherein the input data is programmed as a LSB in the memory when it is determined that there is not a set of second patterns stored within the memory that is of a number substantially similar to the number of first patterns.

9. The memory device of claim 7, wherein the memory is blank.

10. The memory device of claim 7, wherein, when data stored in an LSB programmed cell of the memory and the input data have the same value, only a flag cell of the LSB programmed cell is programmed in writing the input data to the memory cell.

11. The memory device of claim 7, wherein the set of first patterns are identified based on a file format of the input data or based on whether the input data are compressed.

12. The memory device of claim 7, wherein the memory comprises a random access memory (RAM) and a flash memory.

13. The memory device of claim 12, wherein, before a power source is turned off, the processor stores the set of first patterns and the second patterns, which are stored in the RAM, into the flash memory.

14. The memory device of claim 12, wherein, when a power source is turned on, the processor stores the set of first patterns and the second patterns, which are stored in the flash memory, into the RAM.

15. The memory device of claim 7, wherein the memory includes an MLC flash memory.

16. A method of programming a flash memory, the method comprising:
determining a pattern of input data;
searching within a memory for LSB pattern information that is substantially similar to the determined pattern of input data; and
programming the input data as an MSB in a location of the flash memory where the similar LSB pattern information is stored when the similar LSB pattern is found to be in the memory.

17. The method of claim 16, wherein the determining of the pattern comprises:
determining a plurality of LSB patterns; and
counting the respective numbers of the LSB patterns in the input data and outputting the numbers of first patterns.

18. The method of claim 17, wherein the LSB pattern information stored in the memory comprises the numbers of second patterns representing the respective numbers of the LSB patterns.

19. The method of claim 16, wherein the searching of the LSB pattern information comprises searching the most similar numbers of the second patterns among the numbers of the first patterns and the LSB pattern information stored in the memory.
